(19) United States
(12) Patent Application Publication
(10) Pub. No.: US 2013/0050167 A1
(43) Pub. Date: Feb. 28, 2013

(54) LIGHT SOURCE DEVICE, DRIVING DEVICE, AND ELECTRONIC DEVICE

(71) Applicant: Satoru Yamanaka, Fukaya-shi (JP)

(72) Inventor: Satoru Yamanaka, Fukaya-shi (JP)

(21) Appl. No.: 13/466,675

(22) Filed: May 8, 2012

(30) Foreign Application Priority Data
Aug. 31, 2011 (JP) 2011-189978

(51) Int. Cl. G06F 3/038; H05B 37/00

(52) U.S. Cl. 345/211; 315/185 R; 345/204; 345/87

(57) ABSTRACT

According to one embodiment, a light source device includes a driving module having a first predetermined number of control channels, and a light source configured to be driven by the driving module. The light source includes a first unit and a second unit, the first unit includes a second predetermined number of light emitting elements, the second unit includes the second predetermined number of light emitting elements, and the second predetermined number is smaller than the first predetermined number. The first unit is configured to be controlled by a first part of the control channels of the driving module, and the second unit is configured to be controlled by a second part of the control channels of the driving module.

### CROSS-REFERENCE TO RELATED APPLICATIONS

This application is based upon and claims the benefit of priority from prior Japanese Patent Application No. 2011-189978, filed Aug. 31, 2011, the entire contents of which are incorporated herein by reference.

### FIELD

Embodiments described herein relate generally to a light source device, a driving device, and an electronic device.

### BACKGROUND

In recent years, various types of flat video display devices such as displays for a television receiver and a personal computer (PC) have been developed. A liquid crystal display device as an example of the video display device incorporates a backlight for emitting light to the rear surface of a liquid crystal display panel which is turned on/off depending on a pixel data of a video. The video display device can display, more clearly, a video using the light emitted by the backlight.

Development of a video display device using light emitting diodes (LEDs) as a backlight has recently started. Using LEDs as a backlight enables to reduce the power consumption of a video display device as compared with a case in which a fluorescent tube or the like is used as a backlight. Furthermore, LEDs can be incorporated in a small space of a video display device, thereby allowing to develop a flat video display device.

Under the present circumstances, however, a video display device incorporating LEDs further requires a driver for controlling the LEDs. The driver controls the LEDs to emit light when, for example, the video display device is ON. Furthermore, the number of channels which are controllable by the driver at once is determined in advance. The number of LEDs which can be incorporated on one board (unit) for mounting LEDs is determined based on the number of control channels of the driver. Since the illuminance of one LED is low, LEDs are series-connected and are controlled by one control channel of the driver. The LEDs on the board share a common anode. Drivers are configured to control one board. For these reasons, LEDs, the number of which is equal to an integral multiple of the number of control channels, are mounted on one LED board. The productivity of LED boards is therefore low.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary block diagram showing an electronic device according to the first embodiment.

FIG. 2 is an exemplary schematic view showing the arrangement of the electronic device according to the first embodiment.

FIG. 3 is an exemplary view showing an arrangement example of the components of the backlight and its driver of the electronic device of the first embodiment.

FIG. 4 is an exemplary enlarged view showing part of the arrangement of a relay board provided between the backlight and driver of the electronic device of the first embodiment.

FIG. 5 is an exemplary view showing an example of the connection configuration between units each including light emitting diodes and drivers incorporated in the electronic device of the first embodiment.

FIG. 6 is an exemplary view showing an example of the areas of the light emitting diodes driven by the drivers incorporated in the electronic device of the first embodiment.

FIG. 7 is an exemplary view showing an example of the areas of light emitting diodes driven by the drivers incorporated in an electronic device of the second embodiment.

### DETAILED DESCRIPTION

Various embodiments will be described hereinafter with reference to the accompanying drawings.

In general, according to one embodiment, a light source device includes a driving module having a first predetermined number of control channels, and a light source configured to be driven by the driving module. The light source includes a first unit and a second unit, the first unit includes a second predetermined number of light emitting elements, the second unit includes the second predetermined number of light emitting elements, and the second predetermined number is smaller than the first predetermined number. The first unit is configured to be controlled by a first part of the control channels of the driving module, and the second unit is configured to be controlled by a second part of the control channels of the driving module.

### First Embodiment

The first embodiment will be described below with reference to the accompanying drawings.

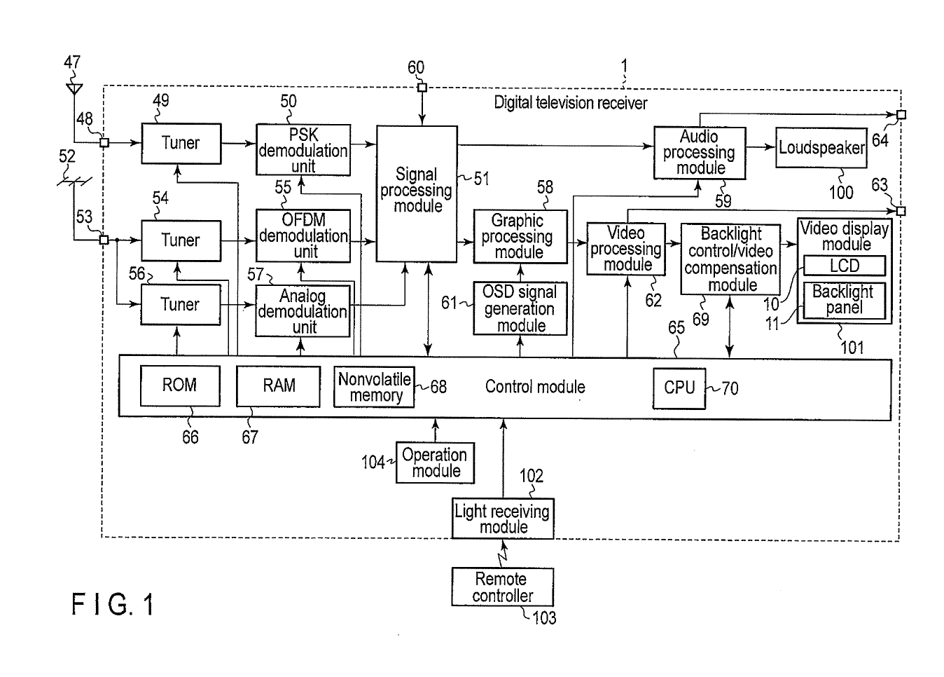

An example of an electronic device according to the first embodiment will be explained with reference to FIG. 1. The electronic device is, for example, a liquid crystal television (LCD television or the like), or a liquid crystal display (LCD display or the like) for a personal computer. With reference to FIG. 1, a digital television receiver 1 as an example of the electronic device will be described.

The digital television receiver 1 includes a video display module 101, a loudspeaker 100, an operation module 104, a light receiving module 102, broadcast signal input terminals 48 and 53, an analog signal input terminal 60, output terminals 63 and 64, tuners 49, 54, and 56, a PSK demodulation unit 50, an OFDM demodulation unit 55, an analog demodulation unit 57, a signal processing module 51, an audio processing module 59, a graphic processing module 58, a video processing module 62, an OSD signal generation module 61, a control module 65, a backlight control/video compensation module 69, and the like.

The broadcast signal input terminals 48 and 53 are connected with a BS/CS digital broadcasting receiving antenna 47 and a terrestrial broadcasting receiving antenna 52, respectively. The light receiving module 102 receives an optical signal output from a remote controller 103.

The control module 65 controls the operation of each component of the digital television receiver 1. The control module 65 includes a CPU 70, a ROM 66, a RAM 67, and a nonvolatile memory 68. The ROM 66 stores control programs executed by the CPU 70. The nonvolatile memory 68 stores various kinds of setting information and control information. The CPU 70 loads, into the RAM 67, a set of instructions and data necessary for processing, and executes the processing.

Operation information input from the operation module 104 or that from the remote controller 103, which is received by the light receiving module 102, is input to the control module 65. The control module 65 controls each component with reflecting the operation contents.

The BS/CS digital broadcasting receiving antenna 47 receives satellite digital television broadcast signals. The BS/CS digital broadcasting receiving antenna 47 outputs the received satellite digital television broadcast signals to the tuner 49 for satellite digital broadcasting via the input terminal 48. The tuner 49 tunes in to a broadcast signal of a channel selected by the user from the broadcast signals. The tuner 49 outputs the tuned broadcast signal to the PSK (Phase Shift Keying) demodulation unit 50. The PSK demodulation unit 50 demodulates the broadcast signal tuned by the tuner 49 into a digital video signal and audio signal. The PSK demodulation unit 50 outputs the demodulated digital video signal and audio signal to the signal processing module 51.

The terrestrial broadcasting receiving antenna 52 receives terrestrial digital television broadcast signals and terrestrial analog television broadcast signals. The terrestrial broadcasting receiving antenna 52 outputs the terrestrial digital television broadcast signals to the tuner 54 via the input terminal 53. The tuner 54 tunes in to a broadcast signal of a channel selected by the user from the broadcast signals. The tuner 54 outputs the tuned broadcast signal to the OFDM (Orthogonal Frequency division Multiplexing) demodulation unit 55. The OFDM demodulation unit 55 demodulates the broadcast signal tuned by the tuner 54 into a digital video signal and audio signal. The OFDM demodulation unit 55 outputs the demodulated digital video signal and audio signal to the signal processing module 51.

The terrestrial broadcasting receiving antenna 52 outputs the terrestrial analog television broadcast signals to the tuner 56 for terrestrial analog broadcasting via the input terminal 53. The tuner 56 tunes in to a broadcast signal of a channel selected by the user from the broadcast signals. The tuner 56 outputs the tuned broadcast signal to the analog demodulation unit 57. The analog demodulation unit 57 demodulates the broadcast signal tuned by the tuner 56 into an analog video signal and audio signal. The analog demodulation unit 57 outputs the demodulated analog video signal and audio signal to the signal processing module 51.

The signal processing module 51 is connected with the input terminal 60. The input terminal 60 is used to externally input an analog video signal and audio signal to the digital television receiver 1. The signal processing module 51 converts an analog video signal and audio signal input via the analog demodulation unit 57 or input terminal 60 into a digital video signal and audio signal, respectively.

The signal processing module 51 executes predetermined digital signal processing for the converted digital video signal and audio signal, and the digital video signal and audio signal input from the PSK demodulation unit 50 or OFDM demodulation unit 55. The signal processing module 51 outputs, to the graphic processing module 58 and audio processing module 59, the video signals and audio signals which have undergone the predetermined digital signal processing.

The audio processing module 59 converts the input digital audio signals into analog audio signals which can be played back by the loudspeaker 100. The audio processing module 59 outputs the analog audio signals to the loudspeaker 100. The loudspeaker 100 plays back an audio based on the input analog audio signals. Furthermore, the audio processing module 59 may externally output the analog audio signals via the output terminal 64.

The graphic processing module 58 superimposes OSD signals for a menu or the like generated by the OSD (On Screen Display) signal generation module 61 on the digital video signals output from the signal processing module 51. The graphic processing module 58 outputs the video signals superimposed with the OSD signals to the video processing module 62. The graphic processing module 58 may selectively output the video signals output from the signal processing module 51 and the OSD signals output from the OSD signal generation module 61.

The video processing module 62 converts the input digital video signals into analog video signals which can be displayed by the video display module 101. The video processing module 62 outputs the analog video signals to the backlight control/video compensation module 69. The video processing module 62 may also externally output the analog video signals via the output terminal 63.

The video display module 101 includes an LCD (Liquid Crystal Display) 10 and a backlight panel 11. Based on the LED backlight control level, the backlight control/video compensation module 69 controls the luminance levels of LEDs 17 (light sources) of the backlight panel 11. That is, depending on the LED backlight control level, the backlight control/video compensation module 69 can set a light amount emitted by each of the LEDs 17 to the LCD 10.

The area control of the backlight panel 11 based on the LED backlight control level will now be described. As described above, the backlight panel 11 includes the LEDs 17 (light sources). A video is displayed on a video region corresponding to the backlight panel 11. The video region includes partial regions. Also, a light source block formed by one or more light sources corresponds to a partial region. That is, light source blocks correspond to the video region including partial regions. Based on the LED backlight control level generated according to the video signals (the luminance of a video), the backlight control/video compensation module 69 can control the luminance of each light source in each light source block, individually.

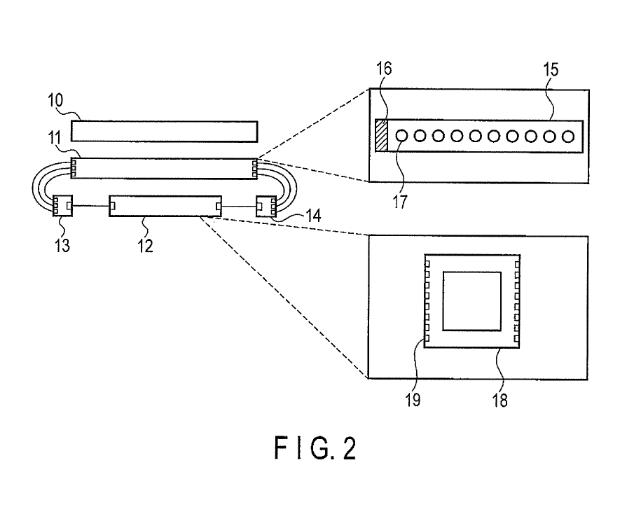

The arrangement of placement and the like of the electronic device according to this embodiment will be described next with reference to FIG. 2. The electronic device includes the LCD 10, the backlight panel 11, a driving device 12, and relay boards 13 and 14. Note that the electronic device may be a television which can display a 3D video.

A schematic sectional view of the electronic device shown on the left side of FIG. 2 will be described first. The upper side of FIG. 2 is the front side of the electronic device, on which it is possible to see a video displayed on the electronic device. The lower side of FIG. 2 is the rear side of the electronic device, on which the control board and the like of the electronic device are arranged.

The LCD 10 is used to display a video on the electronic device. A video is displayed based on signals sent from the control module 65 incorporated in the electronic device to the LCD 10. The LCD 10 is arranged within the electronic device so that light emitted by the backlight panel 11 (to be described later) irradiates the rear surface (the lower side of the sectional view in FIG. 2) of the LCD 10.

The backlight panel 11 includes light emitting sources. The backlight panel 11 includes, for example, LEDs (Light Emitting Diodes) as light emitting sources. In FIG. 2, the backlight panel 11 is of direct type. The electronic device, therefore, is configured so that the LCD 10 is directly irradiated with light emitted by the backlight panel 11 (a direct backlight structure).

The driving device 12 is included in the backlight control/video compensation module 69. The driving device 12 is used to control the LEDs of the backlight panel 11. In an edge type backlight in which irradiation units are provided near the side surface of a display panel, it is difficult to adjust the luminance with high accuracy for each region of a display area. In the direct type backlight, however, an LED is provided for each area of the LCD 10. By controlling the luminance when turning on/off light emitting for each LED, it is possible to control light emission of the backlight with high accuracy according to a video. LEDs corresponding to a display area which displays a dark scene are turned off. LEDs corresponding to a peak white area are caused to emit light with a maximum luminance. With this operation, the dark scene shows solid black, and peak white light can reproduce high contrast without color saturation while maintaining sharpness. Referring to FIG. 2, the driving device 12 is arranged on the rear surface (the lower side of FIG. 2) of the backlight panel 11. The driving device 12 is connected with the backlight panel 11 by cables. Note that the driving device 12 may be arranged on, for example, the right or left surface of the backlight panel 11 other than the rear surface of the backlight panel 11.

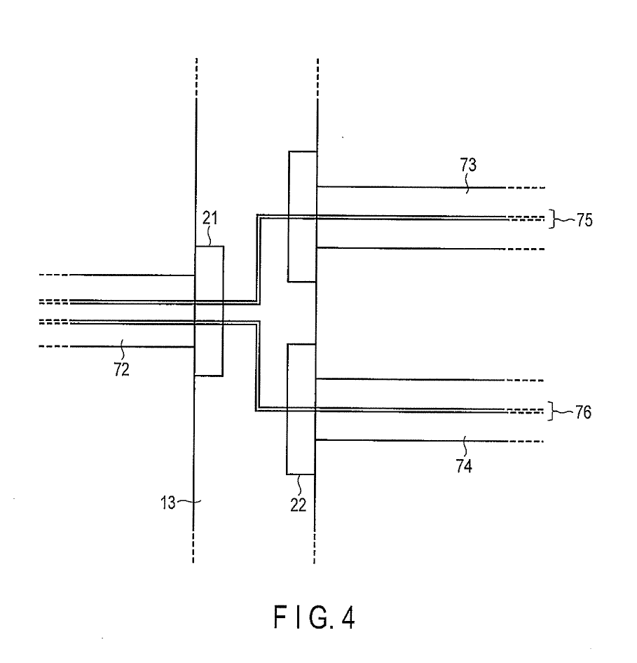

The relay boards 13 and 14 are used to relay cables for connecting the backlight panel 11 with the driving device 12. The relay boards 13 and 14 are used to change the number of cables (driver cables) connected with the driving device 12 to the number of cables (unit cables) connected with the backlight panel 11. As shown in FIG. 2, for example, one cable connected with the driving device 12 is changed to three cables connected with the backlight panel 11. Note that cables may be connected with the driving device 12. A change in number of cables by the relay boards 13 or 14 may be a physical change in number of cables. A physical change in number of cables will be described later with reference to FIG. 4. A change in number of cables in the relay boards 13 or 14 may be implemented by branching a control signal sent from the driving device 12 to the LEDs of the backlight panel 11. For example, because the relay boards 13 or 14 include an integrated circuit, the integrated circuit may, for example, change a control signal to signals.

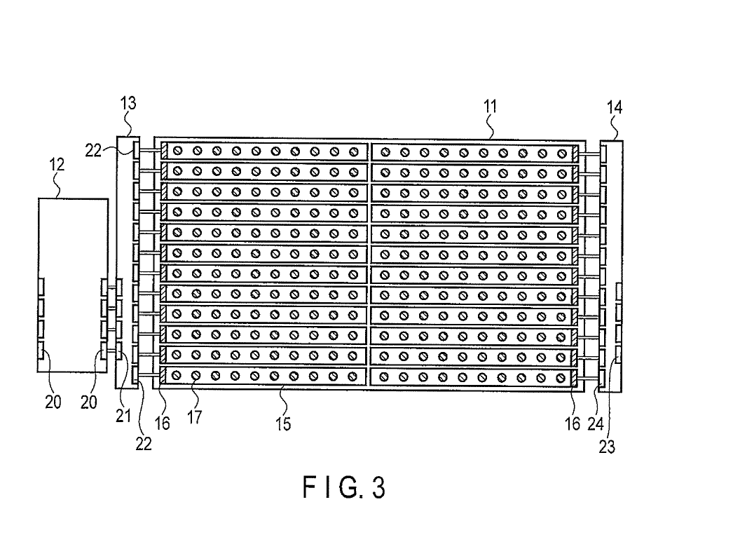

Note that the two ends of a cable for connecting the driving device 12 with the relay board 13 are connected with the driving device 12 and the relay board 13 by connectors 20 and 21, respectively, as shown in FIG. 3. The two ends of each cable for connecting the backlight panel 11 with the relay board 13 are connected with the backlight panel 11 and the relay board 13 by connectors 16 and 22, respectively. Similarly, the two ends of a cable for connecting the driving device 12 with the relay board 14 are connected with the driving device 12 and the relay board 14 by the connector 20 and a connector 23, respectively. The two ends of each cable for connecting the backlight panel 11 with the relay board 14 are connected with the backlight panel 11 and the relay board 14 by the connector 16 and a connector 24, respectively. In this way, by using the relay boards 13 and 14, it is possible to decrease the number of cables connected with the driving device 12. This can prevent the cables connected with the driving device 12 from shorting out. Note that the driving device 12 and the backlight panel 11 may directly be connected by a cable.

The detailed arrangement of the backlight panel 11 and driving device 12 will be described with reference to an enlarged view (plan view) showing some components of the electronic device, which is shown on the right side of FIG. 2. The backlight panel 11 includes units 15 each having the connector 16 and the LEDs 17. Each unit 15 includes, for example, 10 LEDs 17 arranged in a line in the horizontal direction. The LED 17 may have a structure in which n light emitting diodes (LEDs) are series-connected. Assume that the LED 17 is formed by one light emitting diode (LED). The connector 16 is connected with the relay board 13 or 14 by a cable.

The connector 16 may be provided on each end of the unit 15. Note that connectors will be collectively referred to as a connector unit hereinafter. As shown in FIG. 3, for example, half a connector unit formed by the connectors 20 is connected with a connector unit formed by the connectors 21 included in the relay board 13. The backlight panel 11 may include the units 15 or may include only one unit. Although one unit 15 includes the 10 LEDs 17 in FIG. 2, any other number of LEDs 17, for example, one, five, or 16 LEDs 17 may be provided. The LEDs 17 are arranged in a line in the horizontal direction. The LEDs 17, however, may be arranged in two lines in the vertical direction in the unit 15, or may be randomly arranged in the unit 15.

An enlarged view showing the detailed arrangement of the driving device 12 will be described with reference to the plan view on the right side of FIG. 2. Some components of the driving device 12 include an LED driver 18 formed by an integrated circuit and the like. The LED driver 18 includes terminals (to also be referred to as control channels hereinafter) 19, as shown in FIG. 2. Referring to FIG. 2, the LED driver 18 includes 16 control channels. Each of the 16 control channels is connected with one LED 17. That is, one control channel can control one LED 17. The driving device 12 may include LED drivers 18 shown in FIG. 2.

Note that one control channel may control the LEDs 17. More specifically, if the LEDs 17 are connected by one control channel, the one control channel may control the LEDs 17. If the LED 17 has a structure in which light emitting diodes are series-connected, one control channel can control the light emitting diodes by being connected with one LED 17. Furthermore, in FIG. 2, the IC includes the 16 control channels. The present embodiment, however, is not limited to this, and for example, one, 10 or 20 control channels may be included.

As described above, in this embodiment, the number of control channels included in the IC of the driving device 12 is different from the number of LEDs 17 included in the unit 15 of the backlight panel 11. Note that a case in which the number of control channels is larger than that of LEDs 17 included in the unit 15 is assumed in FIG. 2. However, the number of control channels may be smaller than that of LEDs 17 included in the unit 15.

The overall arrangement of the backlight panel 11, driving device 12, and relay board 13 or 14 of this embodiment will be described in detail with reference to FIG. 3. FIG. 3 is a view showing the arrangement of some components of the electronic device of this embodiment. FIG. 3 is a view when seen from the upper side of FIG. 2 by developing the components of the electronic device shown on the left side of FIG. 2 except for the LCD 10 and the cables for connecting the backlight panel 11 with the relay board 14. That is, FIG. 3 is a plan view showing the components except for the LCD 10 and the cable for connecting the driving device 12 with the relay board 14. Note that the plan view of FIG. 3 is obtained by seeing from the upper side of the sectional view of FIG. 2. The cable for connecting the driving device 12 with relay board 14 is not shown for simplicity. Furthermore, the number of cables for connecting the driving device 12 with the relay board 13 or 14 in FIG. 2, and the number of cables for connecting the relay board 13 or 14 with the backlight panel 11 in FIG. 2 are different from those in FIG. 3 since FIG. 3 shows more details.

Referring to FIG. 3, the driving device 12 is connected with the relay board 13 via the connectors 20 and 21 by four cables. The backlight panel 11 includes the units 15 arranged in a 2×12 matrix. The relay board 13 is connected with the units 15 included in the backlight panel 11 via the connectors 22 and 16 by 12 cables.

Factors for determining the number of LEDs 17 included in one unit 15 will be described. One factor is the light irradiating capacity of the LED 17. A light amount emitted by one LED 17 is limited. Therefore, the number of LEDs 17 necessary for obtaining an appropriate light amount to show a video displayed on the LCD 10 is determined. Another factor is the light diffusing capacity of the LED 17. The LED 17 includes a lens for diffusing light emitted by light emitting diodes (not shown). The range of light diffused by the lens is limited. Although there are various factors other than these two factors, a minimum number of LEDs 17 which can be incorporated in one unit 15 is determined in consideration of the above-described two factors.

In this embodiment, the backlight panel 11 uses 24 units 15 in total each including 10 LEDs 17. Furthermore, in this embodiment, the minimum number of LEDs 17 is determined regardless of the number of control channels of the driving device 12 for controlling the LEDs 17. In other words, the number of LEDs 17 mounted on one unit 15 need not be equal to the number of LEDs 17 controllable by the driving device 12.

The arrangement of the relay boards 13 and 14 will be described with reference to FIG. 4. FIG. 4 is an enlarged view showing a part of the wiring pattern of the electronic device of this embodiment.

The relay board 13 includes a connector unit having the connectors 21 and a connector unit having the connectors 22. FIG. 4 is an enlarged view showing a part of the relay board 13 including parts of these connector units. A cable 72 is connected with the connector 21. Cables 73 and 74 are connected with the different connectors 22. Note that the cable may be, for example, a flexible flat cable (FFC) which can bundle a plurality of wiring lines into one wiring line. A wiring section 75 or 76 includes a plurality of wiring lines. The wiring section 75 or 76 may include wiring lines (anode terminal wiring lines) connected with the anode terminals of the LEDs 17 and wiring lines (cathode terminal wiring lines) connected with the cathode terminals of the LEDs 17. In this embodiment, the wiring section 75 or 76 includes three anode terminal wiring lines and 10 cathode terminal wiring lines. Note that FIG. 4 shows the wiring section 75 or 76 by two wiring lines for descriptive convenience.

The cable 72 includes the wiring sections 75 and 76. The wiring sections 75 and 76 are arranged within the relay board 13 or 14 so that the wiring section 75 extends through the cable 73 and the wiring section 76 extends through the cable 74. As described above, the wiring line for connecting the units 15 with the driving device 12 branches into a plurality of wiring lines in the relay board 13 or 14. In this way, it is possible to physically change the number of cables by branching a wiring line. More specifically, referring to FIG. 4, the number (one) of cables 72 connected with the connector 21 is changed to the number (two) of cables 73 and 74 connected via the connector unit including the two connectors 22.

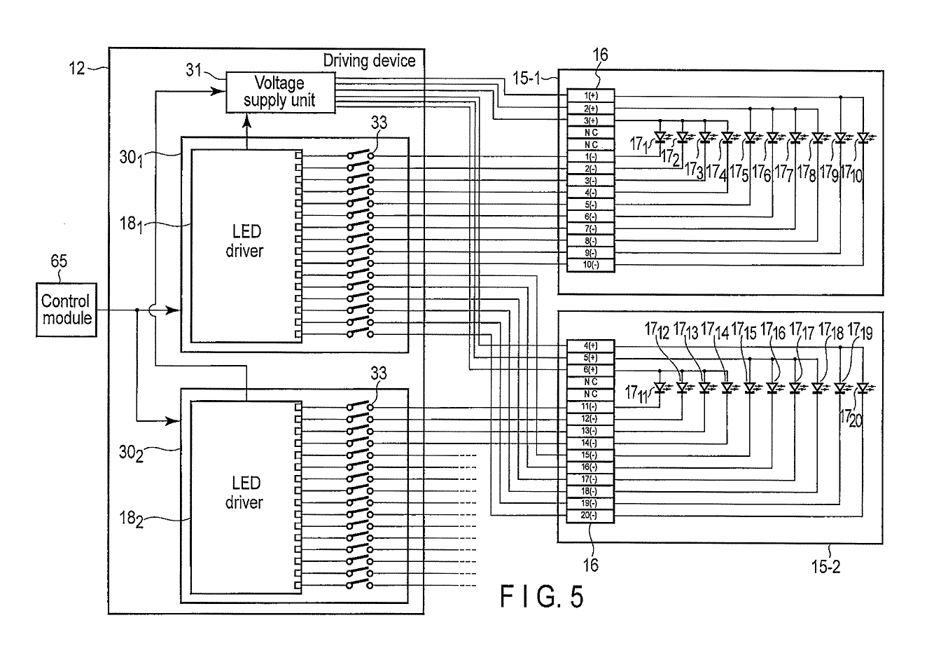

The function of the driving device 12 and the more detailed arrangement of the unit 15 will be described with reference to FIG. 5. FIG. 5 is a view showing, in detail, control of light emitting diodes according to this embodiment.

The driving device 12 includes control units 30 and a voltage supply unit 31. In FIG. 5, the driving device 12 is connected with the unit 15 without intervention of the relay board 13 or 14 for descriptive convenience. Furthermore, in FIG. 5, the driving device 12 is connected with two units 15 (15-1 and 15-2) for descriptive convenience. In this embodiment, assume that the driving device 12 incorporates 15 control units 30. Note that only two control units 30 (30₁ and 30₂) are shown in FIG. 5 for descriptive convenience.

Each control unit 30 includes, for example, the LED driver 18 (18₁ or 18₂) and switches 33. Note that each LED driver 18 may include the switches 33. Each LED driver 18 includes 16 control channels for the LEDs 17. The 16 control channels are connected with the LEDs 17 via the different switches 33, respectively. More specifically, one of the 16 control channels of the LED driver 18₁ is connected with the cathode terminal of the LED 17₁ via a terminal 1(−) of the connector 16. Similarly, nine of the 10 control channels, connected with the unit 15-1, of the LED driver 18₁ are connected with the LEDs 17₂ to 17₁₀ via terminals 2(−) to 10(−) of the connector 16, respectively. Six of the 16 control channels of the LED driver 18₁ are connected with the LEDs 17₁₅ to 17₂₀ via terminals 15(−) to 20(−) of the connector 16 of the unit 15-2, respectively. Moreover, four of the 16 control channels of the LED driver 18₂ are connected with the LEDs 17₁₁ to 17₁₄ via terminals 11(−) to 14(−) of the connector 16 of the unit 15-2. One LED driver 18 is thus connected with the LEDs 17 included in the units 15.

Each switch switches ON/OFF of the corresponding LED 17. ON/OFF switching is performed when the LED driver 18 controls the value of a current passing through the LED 17. In this case, the control unit 30 may detect a change in value of a current passing through the LED 17. Alternatively, the control unit 30 may monitor, as needed, the value of a current passing through the LED 17. The LEDs 17 may be respectively assigned with identifiable information such as different addresses.

The control module 65 serves as, for example, a host device incorporated in the electronic device. The control module 65 is connected with the control units 30₁ and 30₂. Based on an address assigned to each LED driver 18, the control module 65 sends a command to the LED driver 18 to control the LEDs 17. Each LED driver 18 controls the LEDs 17 based on the command.

The voltage supply unit 31 supplies a voltage to the LEDs 17 in response to an instruction from each LED driver 18. The voltage supply unit 31 is, for example, a DC/DC converter or the like. The voltage supply unit 31 is connected with the anode terminals of the LEDs 17. More specifically, the voltage supply unit 31 is connected with the anode terminals of the LEDs 17 included in the unit 15-1 via terminals 1(+) to 3(+) of the connector 16 of the unit 15-1. The voltage supply unit 31 is connected with the anode terminals of the LEDs 17 included in the unit 15-2 via terminals 4(+) to 6(+) of the connector 16 of the unit 15-2. The voltage supply unit 31 is also connected with the LED drivers 18₁ and 18₂. The voltage supply unit 31 supplies a voltage to the anode terminals of the LEDs 17 in response to instructions from the LED drivers 18₁ and 18₂. Although one voltage supply unit 31 is shown in FIG. 5, the driving device 12 may include, for example, six voltage supply units 31. In this case, the six voltage supply units 31 are connected with the terminals 1(+) to 6(+), respectively. Three of the six voltage supply units 31 may be connected with the LED driver 18₁. The six voltage supply units may supply different voltages to the anode terminals of the LEDs 17 connected with the terminals 1(+) to 6(+) of the connector 16, respectively.

Referring to FIG. 5, the anode terminals of the 10 LEDs 17 of the unit 15 are divided at a ratio of 4:4:2. By dividing the anode terminals, the units 15 (the two units 15 in FIG. 5) each including the LEDs 17 the number of which is smaller than that of control channels (the 16 control channels in FIG. 5) of the LED driver 18 can be connected with the one LED driver 18. More specifically, the anode terminals of the four LEDs 17₁ to 17₄ among the 10 LEDs 17 of the unit 15 are connected with the terminal 3(+) of the connector 16 as a common node. Similarly, the anode terminals of the LEDs 17₅ to 17₈ are connected with the terminal 2(+) of the connector 16 as a common node. Furthermore, the anode terminals of the LEDs 17₉ and 17₁₀ are connected with the terminal 1(+) of the connector 16 as a common node. As described above, the voltage supply unit 31 is connected with the 10 LEDs 17 of the unit 15 by three wiring lines.

The voltage supply unit 31 is connected with the 10 LEDs 17 by three different wiring lines. The LED driver 18 can instruct the voltage supply unit 31 to supply three different voltages to the 10 LEDs 17. That is, the voltage supply unit 31 need not supply the same voltage to the 10 LEDs 17. More specifically, for example, the voltage supply unit 31 can supply the same voltage to the LEDs 17₁ to 17₄. The control unit 30, therefore, can control the voltage of the LEDs 17₁ to 17₄ among the 10 LEDs 17. Due to variation in manufacturing light emitting diodes, a voltage necessary for causing a light emitting diode to emit light is different for each light emitting diode. To compensate for the variation, the control unit 30 controls voltages supplied to the anode terminals of the LEDs 17. The unit 30, for example, controls to stabilize the brightness (illuminance) of light emitted by a light emitting diode.

The connector 16 includes 15 terminals. The voltage supply unit 31 is connected with the anode terminals of the 10 LEDs 17 via three of the 15 terminals. The LED driver 18 is connected with the cathode terminals of the 10 LEDs 17 via 10 remaining terminals. That is, one unit 15 is connected with 13 wiring lines in total for three anode terminals and 10 cathode terminals. Two terminals indicated by NC of the connector 16 are not used.

Note that the control module 65 may determine ON/OFF of the LEDs 17 depending on the contrast of a video displayed on the LCD 10. More specifically, for example, assume that part of a video displayed on the LCD 10 is dark. In this case, the switches 33 may turn off the LEDs 17 in a region of the backlight panel 11 corresponding to a region of the LCD 10 which displays the dark part. In this case, the control unit 30 may control the switches 33 to make the brightness of the LEDs 17 suitable for the video. This makes it possible to control the value of a current passing through the LEDs 17.

In FIG. 5, one control channel controls one LED 17. One control channel, however, may control a plurality of series-connected LEDs 17. More specifically, for example, assume that six LEDs 17 are series-connected. In this case, the LED driver 18 controls light emitting diodes the number of which is equal to an integral multiple (six times in this case) of the number of control channels (the 16 control channels) of the LED driver 18, that is, 96 light emitting diodes. As described above, by controlling light emitting diodes the number of which is equal to an integral multiple of the number of control channels, it is possible to control the LEDs 17 within a wider range of luminance values.

Moreover, each of the 10 LEDs 17 need not be controlled by one switch. More specifically, the cathode terminals of the LEDs 17₁ to 17₄ may be connected by a common node, and one switch may switch ON/OFF of the node. This decreases the number of control channels necessary for controlling the LEDs 17. Therefore, it is possible to, for example, decrease the number of LED drivers 18 incorporated in the driving device 12.

Note that, in FIG. 5, the anode terminals of the 10 LEDs 17 are divided at a ratio of 4:4:2 and each group of the anode terminals are connected by common nodes, respectively. Instead of the ratio of 4:4:2, another ratio of 3:5:2 or 2:2:2:4 may be used.

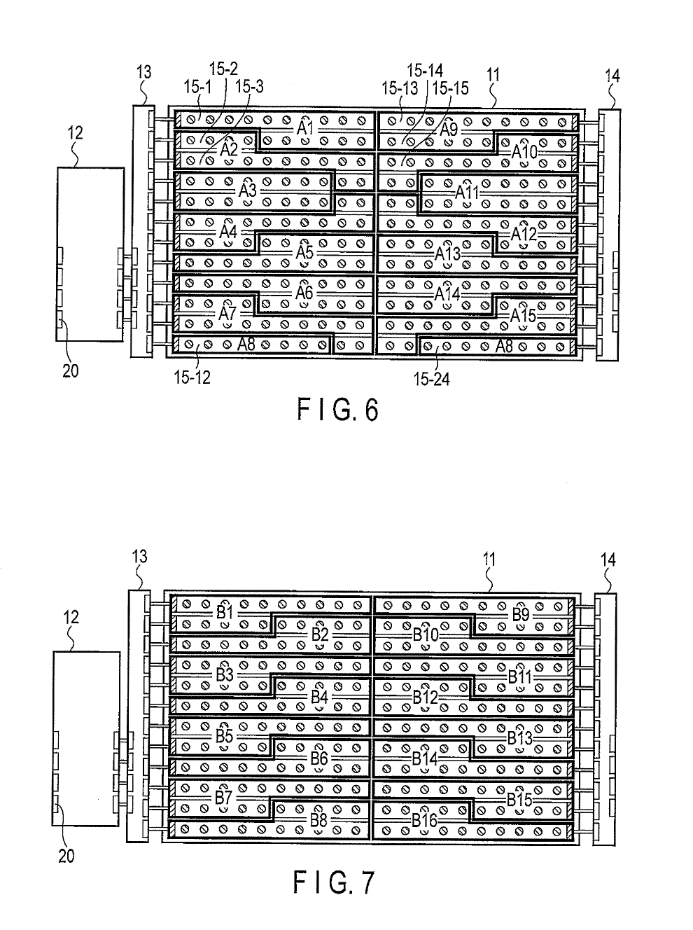

A region on the backlight panel 11, which is controlled by the LED drivers 18, will be described with reference to FIG. 6. FIG. 6 is a view showing an example of areas of the LEDs 17 driven by the driving device 12 according to the first embodiment.

In FIG. 6, the driving device 12 incorporating 15 LED drivers 18 each including 16 control channels is assumed. As described above with reference to FIG. 3, the 24 units 15 are arranged in a 2×12 matrix on the backlight panel 11. As described above with reference to FIG. 5, each unit 15 is connected with the voltage supply unit 31 by the three wiring lines. In FIG. 6, therefore, the driving device 12 may incorporate 72 voltage supply units 31 to supply different voltages to the three wiring lines for the anode terminals, divided at a ratio of 4:4:2, of each unit 15. Reference symbols A1 to A15 denote regions on the backlight panel 11 which are controlled by the 15 LED drivers 18, respectively. The regions A1 and A2 shown in FIG. 6 are regions controlled by the different LED drivers 18. As described above with reference to FIG. 5, each unit 15 is connected with the corresponding LED driver 18 by 10 wiring lines. Furthermore, as described above with reference to FIG. 5, in each unit 15, the anode terminals of the 10 LEDs 17 are divided at a ratio of 4:4:2 and each group of anode terminals is connected by a common node.

An area on the backlight panel 11, which is controlled by each LED driver 18, will be described in detail. The area indicates a region on the backlight panel 11, which has LEDs 17 controlled by one control channel. For example, the region A1 includes 16 areas. In this embodiment, the 15 LED drivers 18 will be referred to as LED drivers 18₁, 18₂, . . . , 18₁₅. The LED driver 18₁ is connected with 10 LEDs 17 of the first unit 15 (to be referred to as the unit 15-1 hereinafter) from the top in the left column on the backlight panel 11, and six LEDs 17 of the second unit 15 (to be referred to as the unit 15-2) from the top in the same column. In other words, the LED driver 18₁ controls all the LEDs 17 of the unit 15-1 and some LEDs 17 of the unit 15-2. The LED driver 18₁ controls the LEDs 17 of the 16 areas of the region A1. The units 15 from top to bottom in the left column on the backlight panel 11 will be referred to as units 15-1, 15-2, 15-3, . . . , 15-12 hereinafter. For example, the third unit 15 from the top in the left column on the backlight panel 11 will be referred to as the unit 15-3, and the 12th unit 15 from the top in the left column on the backlight panel 11 will be referred to as the unit 15-12. Similarly, the units 15 from top to bottom in the right column on the backlight panel 11 will be referred to as units 15-13, 15-14, 15-15, . . . , 15-24 hereinafter.

The LED driver 18₂ is connected with four LEDs 17 included in the unit 15-2, 10 LEDs 17 included in the unit 15-3, and two LEDs 17 included in the unit 15-4 in the region A2 including 16 areas, and controls the LEDs 17 in the 16 areas. In other words, the LED driver 18₂ controls the LEDs 17 included in the three units 15-2 to 15-4.

Similarly, each of the LED drivers 18₃ to 18₇ and 18₉ to 18₁₅ controls the LEDs 17 included in two or three units. Furthermore, each of the LED drivers 18₁ to 18₁₅ (except for the LED driver 18₈) is connected with the plurality of units 15 via the relay board 13 or 14.

The LED driver 18₈ controls 8 LEDs 17 included in each of the two units 15-12 and 15-24. That is, the LED driver 18₈ controls the LEDs 17 included in the unit 15-12 via the relay board 13, and controls the LEDs 17 included in the unit 15-24 via the relay board 14.

Note that each LED driver 18 may be connected with the LEDs 17 included in four or more units 15, and may control the connected LEDs 17. As shown in FIG. 6, the areas on the backlight panel 11, which are controlled by the LED drivers 18, are merely an example. In FIG. 6, the LED driver 18₁ controls the LEDs 17 in the 10 areas included in the unit 15-1 and the LEDs 17 in the six adjacent areas included in the unit 15-2. The LED driver 18₁, however, may control the LEDs 17 in six nonadjacent areas included in the unit 15-2. The six nonadjacent areas included in the unit 15-2 are, for example, four areas from the left of the unit 15-2 shown in FIG. 6 and two areas from the right of the unit 15-2.

As described above, by implementing the first embodiment, the driving device 12 can drive a plurality of units incorporated in the backlight panel 11 using all the control channels of the LED drivers 18 incorporated in the driving device 12 even if one unit 15 includes the LEDs 17 the number of which is smaller than that of control channels of one LED driver 18. Furthermore, it is possible to develop an electronic device for which an area on the backlight panel 11, which is controlled by one LED driver 18, can be freely selected in designing the electronic device by dividing the anode terminals of the LEDs 17 included in one unit 15 depending on the number of control channels and that of LEDs 17 included in the unit 15.

### Second Embodiment

The second embodiment will be described below with reference to the accompanying drawings.

Note that a description of functions and arrangements similar to those in the first embodiments will be omitted.

Areas on a backlight panel 11 controlled by a plurality of LED drivers 18 according to the second embodiment will be described with reference to FIG. 7. FIG. 7 is a view showing an example of the areas of LEDs 17 driven by a driving device 12 according to the second embodiment. In the second embodiment, the driving device 12 incorporates 16 LED drivers 18. In FIG. 7, reference symbols B1 to B16 denote regions, on the backlight panel 11, which are controlled by the 16 LED drivers 18, respectively and each of which includes 15 areas.

Unlike the areas of LEDs 17 controlled by respective LED drivers 18, which have been described with reference to FIG. 6 in the first embodiment, each LED driver controls the 15 LEDs 17 in the second embodiment. More specifically, for example, the LED driver 18₁ controls 10 LEDs 17 included in a unit 15-1 and five LEDs 17 included in a unit 15-2. Similarly, each of the 16 LED drivers 18 is connected with two units 15, as shown in FIG. 7. Each of the 16 LED drivers 18 controls half (five LEDs 17 in FIG. 7) the LEDs 17 included in one of the two units 15 and all the LEDs 17 (10 LEDs 17 in FIG. 7) included in the other unit. That is, in the second embodiment, each LED driver uses 15 of 16 control channels to control the 15 LEDs 17.

Furthermore, in the second embodiment, the driving device 12 may incorporate four voltage supply units 31. Each of the four voltage supply units 31 may supply the same voltage to the LEDs 17 included in each of four regions obtained by dividing the backlight panel 11.

More specifically, the four regions include units 15-1 to 15-6, 15-7 to 15-12, 15-13 to 15-18, and 15-19 to 15-24, respectively. Each of the four voltage supply units 31 supplies the same voltage to the anode terminals of the 10 LEDs 17 of each unit 15 included in each region.

With respect to a wiring line for connecting the driving device 12 with each unit 15, therefore, a plurality of anode terminals supplied with the same voltage may be connected with the same node in a relay board 13 or the same node in the driving device 12. Wiring sections 75 and 76 shown in FIG. 4, for example, may be connected by the relay board 13. Alternatively, six wiring lines (not shown in FIG. 5) for connecting the voltage supply unit 31 with each of terminals 1(+) to 6(+) of a connector 16 in FIG. 5 may be connected by one node in the driving device 12, and the voltage supply unit 31 may be connected with one wiring line. Each of the four voltage supply units 31 may be controlled by four of the 16 LED drivers 18. More specifically, in FIG. 5, two LED drivers 18 are connected with one voltage supply unit 31, and control the voltage supply unit 31. Similarly, four LED drivers 18 may be connected with one of the four voltage supply units 31 incorporated in the driving device 12, and may control the connected voltage supply unit 31.

Note that instead of the four regions obtained by dividing the backlight panel 11, for example, two regions as left and right columns of the backlight panel 11 may be assumed. In this case, the driving device 12 may incorporate two voltage supply units 31 and the two voltage supply units may supply voltages to the LEDs 17 included in the units 15 mounted on the backlight panel 11.

As described above, by implementing the second embodiment, for example, it is possible to prevent heat generation of each LED driver 18 since not all control channels controllable by one LED driver 18, are used. Furthermore, since a small umber of voltage supply units 31 as much as possible are used, voltages supplied to the LEDs 17 are readily controlled.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A light source device comprising:
a driving module comprising a first predetermined number of control channels; and
a light source configured to be driven by the driving module,
wherein the light source comprises a first unit and a second unit, the first unit comprises a second predetermined number of light emitting elements, the second unit comprises the second predetermined number of light emitting elements, and the second predetermined number is smaller than the first predetermined number,
wherein the first unit is configured to be controlled by a first part of the control channels of the driving module, and
wherein the second unit is configured to be controlled by a second part of the control channels of the driving module.

2. The light source device of claim 1, wherein
first ends of a first part of the second predetermined number of the light emitting elements are configured to be connected with a first voltage terminal,
wherein first ends of a second part of the second predetermined number of the light emitting elements are configured to be connected with a second voltage terminal, and
wherein second ends of the second predetermined number of the light emitting elements are configured to be respectively connected with the control channels of the driving module.

3. The light source device of claim 1, further comprising
a third unit comprising the second predetermined number of light emitting elements,
wherein the third unit is configured to be controlled by a third part of the control channels of the driving module.

4. The light source device of claim 1, wherein each of the light emitting elements comprises a light emitting diode or a plurality of series-connected light emitting diodes.

5. A driving device for driving a light source device comprising a first unit and a second unit, the first unit and the second unit comprise a first predetermined number of light emitting elements, the driving device comprising:
a second predetermined number of control channels, the second predetermined number being larger than the first predetermined number,
wherein a first part of the control channels is configured to control the first unit, and
wherein a second part of the control channels is configured to control the second unit.

6. The driving device of claim 5, further comprising:
a voltage supply module configured to supply a first voltage to first ends of a first part of the light emitting elements in each of the first unit and the second unit, and to supply a second voltage to first ends of a second part of the light emitting elements in each of the first unit and the second unit,
wherein the first part of the control channels is configured to be connected with second ends of the first part of the light emitting elements in the first unit, and
wherein the second part of the control channels is configured to be connected with second ends of the second part of the light emitting elements in the second unit.

7. The driving device of claim 5, wherein
the light source device further comprises a third unit comprising the first predetermined number of light emitting elements, and
wherein a third part of the control channels is configured to control the third unit.

8. An electronic device comprising:
a light source device comprising a first unit and a second unit, the first unit comprises a first predetermined number of light emitting elements, the second unit comprises a first predetermined number of light emitting elements;
a driving module configured to control the light source device; and
a liquid crystal display panel configured to be irradiated by the light source device,
wherein the driving module comprises a second predetermined number of control channels, the second predetermined number being larger than the first predetermined number,
wherein a first part of the control channels is configured to control the first unit, and
wherein a second part of the control channels is configured to control the second unit.

9. The electronic device of claim 8, further comprising:
a voltage supply module configured to supply a first voltage to first ends of a first part of the light emitting elements in each of the first unit and the second unit, and to supply a second voltage to first ends of a second part of the light emitting elements in each of the first unit and the second unit,
wherein the first part of the control channels is configured to be connected with second ends of the first part of the light emitting elements in the first unit, and
wherein the second part of the control channels is configured to be connected with second ends of the second part of the light emitting elements in the second unit.

10. The electronic device of claim 8, wherein
the light source device further comprises a third unit comprising the first predetermined number of light emitting elements, and
wherein a third part of the control channels is configured to control the third unit.

11. The electronic device of claim 8, wherein the driving module is configured to control the light source device according to a video displayed on the liquid crystal display panel.

12. The electronic device of claim 9, wherein the voltage supply module is configured to control the first voltage and the second voltage so that each of the light emitting elements in the light source device emits light with a desired illuminance.
